(19) United States
(12) Patent Application Publication
(10) Pub. No.: US 2014/0269229 A1
(43) Pub. Date: Sep. 18, 2014

(54) TIMEKEEPING APPARATUS

(71) Applicant: Ursula Boudreaux, Henderson, NV (US)

(72) Inventor: Ursula Boudreaux, Henderson, NV (US)

(21) Appl. No.: 13/844,738

(22) Filed: Mar. 15, 2013

(51) Int. Cl. G04B 19/16

(52) U.S. Cl. CPC G04B 19/163
USPC 368/231

(57) ABSTRACT

An analog timekeeping apparatus includes an hour hand, a minute hand, a disc including twelve or more of the digits 1 through 24 displayed thereon generally circumferentially with digits between 1 and 12 alternating with digits 13 between 24; a faceplate disposed over top of the disc, the faceplate comprising a plurality of openings configured to allow generally half of the numbers to be visible through the openings at one time; wherein the apparatus is configured to automatically transition from a first configuration displaying some or all digits between 1 and 12 to a second configuration displaying some or all digits between 13 and 24.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to timekeeping apparatus. Many digital timekeeping apparatus are configured to display a time in civilian time (utilizing two twelve hour periods) or military time (utilizing one twenty four hour period). However, some people prefer analog timekeeping apparatus.

A need exists for improvement in timekeeping apparatus. This, and other needs, are addressed by one or more aspects of the present invention.

### SUMMARY OF THE INVENTION

The present invention includes many aspects and features. Moreover, while many aspects and features relate to, and are described in, the context of a watch or clock, the present invention is not limited to use only in these contexts, as will become apparent from the following summaries and detailed descriptions of aspects, features, and one or more embodiments of the present invention.

Accordingly, one aspect of the present invention relates to a watch, another relates to a clock, and still another relates to other devices having a clock face.

Another aspect relates to

In addition to the aforementioned aspects and features of the present invention, it should be noted that the present invention further encompasses the various possible combinations and subcombinations of such aspects and features. Thus, for example, any aspect may be combined with an aforementioned feature in accordance with the present invention without requiring any other aspect or feature.

### BRIEF DESCRIPTION OF THE DRAWINGS

One or more preferred embodiments of the present invention now will be described in detail with reference to the accompanying drawings, wherein the same elements are referred to with the same reference numerals, and wherein,

FIG. 1 illustrates a face of an analog timekeeping apparatus in a first configuration

FIG. 2 illustrates the face of the timekeeping apparatus in a second configuration.

FIG. 3 is an exploded schematic view of an exemplary faceplate lifted off of an exemplary disc.

FIG. 4 illustrates rotation of a disc to effect transition from one configuration to another.

### DETAILED DESCRIPTION

As a preliminary matter, it will readily be understood by one having ordinary skill in the relevant art (“Ordinary Artisan”) that the present invention has broad utility and application. As should be understood, any embodiment may incorporate only one or a plurality of the above-disclosed aspects of the invention and may further incorporate only one or a plurality of the above-disclosed features. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

Turning now to the drawings, FIG. 1 illustrates a face of an analog timekeeping apparatus in a first configuration. In the first configuration, the timekeeping apparatus displays hours 1 through 12. FIG. 2 illustrates the face of the timekeeping apparatus in a second configuration. In the second configuration, the timekeeping apparatus displays hours 13 through 24. The timekeeping apparatus is configured to transition between the first and second configurations automatically.

In one or more preferred implementations, the timekeeping apparatus comprises a faceplate comprising openings configured to allow numbers displayed on a disc disposed therebelow to be visible. FIG. 3 is an exploded schematic view of an exemplary such faceplate lifted off of an exemplary such disc. Preferably, such a timekeeping apparatus is configured to transition from the first configuration to the second configuration by rotating such a disc in a first direction, and further configured to then subsequently transition back to the first configuration by rotating such disc in a second direction which is generally opposite to the first direction, as generally schematically illustrated by FIG. 4.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

What is claimed is:

1. An analog timekeeping apparatus comprising:
(a) an hour hand;
(b) a minute hand;
(c) a disc including twelve or more of the digits 1 through 24 displayed thereon generally circumferentially with digits between 1 and 12 alternating with digits 13 between 24;
(d) a faceplate disposed over top of the disc, the faceplate comprising a plurality of openings configured to allow generally half of the numbers to be visible through the openings at one time;
(e) wherein the apparatus is configured to automatically transition from a first configuration displaying some or all digits between 1 and 12 to a second configuration displaying some or all digits between 13 and 24.

2. An apparatus as disclosed.

3. A method as disclosed.
